(19) United States
(12) Patent Application Publication
(10) Pub. No.: US 2026/0121399 A1
(43) Pub. Date: Apr. 30, 2026

(54) Contactor Position and Failure Detection System

(71) Applicant: Caterpillar Inc., Peoria, IL (US)

(72) Inventors: Avinash P. Dongare, Bengaluru (IN); James K. McCloskey, Barnack (GB); Matthew P. Jacoutot, London (GB); Michael David Smith, Huntingdon (GB)

(73) Assignee: Caterpillar Inc., Peoria, IL (US)

(21) Appl. No.: 18/932,934

(22) Filed: Oct. 31, 2024

(51) Int. Cl. H02H 7/18; H01M 10/42; H02H 1/00

(52) U.S. Cl. CPC H02H 7/18; H01M 10/425; H02H 1/0007; H01M 2010/4271

(57) ABSTRACT

A method for distinguishing faults for at least one battery module on a voltage bus, the at least one battery module being switchable between an ON state and an OFF state, includes: commanding a positive contactor of the at least one battery module to open; determining whether a switch of the positive contactor indicates the positive contactor is open or closed, and: if the switch of the positive contactor indicates the positive contactor is open, commanding a negative contactor of the at least one battery module to open, or if the switch of the positive contactor indicates the positive contactor is closed, comparing a bus voltage of the voltage bus to a first bus voltage threshold, and: if the bus voltage is less than the first bus voltage threshold, commanding the negative contactor to open.

### TECHNICAL FIELD

The present disclosure generally relates to methods, battery architectures, and controllers for distinguishing faults associated with one or more battery modules from feedback switch malfunctions of one or more contactors associated with the one or more battery modules.

### BACKGROUND

Contactors are the only way to disconnect a battery from a high voltage (“HV”) bus in a controlled way to protect both users of the battery and the battery itself during safety violations. Different safety strategies for battery management systems (“BMS”) need to be calibrated carefully to determine when contactors are open or closed, including: ensuring the HV bus is isolated when needed (i.e., all contactors are open); ensuring contactors are only closed in specific orders to prevent excessive inrush current; ensuring contactors are opened at low current conditions to maximize contactor life; and, in the event of a fault, ensuring contactors are opened in specific orders to allow for maximum current opening capability.

Contactors can have embedded feedback switches that are mechanically linked to main contacts of the contactors to detect the position/status of the main contacts (i.e., open or closed). Various failure modes can occur when using this approach, potentially resulting in incorrect determination of contactor position, including: an open circuit of the feedback switch or interconnecting means and the feedback switch and/or linkage to main contacts becoming stuck.

US 8,885,304 concerns a drive force distribution control apparatus that prevents reduction in the stability of a vehicle, which may occur if it is erroneously determined that a relay is stuck open due to a temporary decrease in the battery voltage causing the vehicle drive mode to be switched unnecessarily from four-wheel-drive to two-wheel-drive. A drive force distribution control apparatus is provided such that if a relay output voltage detected by a relay-output-voltage detecting means is lower than a first threshold, the relay is repeatedly and successively turned on and off multiple times, and then if the relay output voltage detected later by the relay-output-voltage detecting means while the engine speed is higher than a second threshold and an ignition switch is on is still lower than the first threshold, it is determined that there is an abnormality that keeps the relay stuck open, and then switching the drive mode from four-wheel-drive to two-wheel-drive occurs. No actions are taken to restore contactor functionality for stuck closed faults, nor are voltage sensors used.

### SUMMARY

One aspect of the present disclosure is directed to a method for distinguishing faults for at least one battery module on a voltage bus, the at least one battery module being switchable between an ON state and an OFF state, the method comprising: commanding a positive contactor of the at least one battery module to open; determining whether a switch of the positive contactor indicates the positive contactor is open or closed, and: if the switch of the positive contactor indicates the positive contactor is open, commanding a negative contactor of the at least one battery module to open, or if the switch of the positive contactor indicates the positive contactor is closed, comparing a bus voltage of the voltage bus to a first bus voltage threshold, and: if the bus voltage is less than the first bus voltage threshold, commanding the negative contactor to open, or if the bus voltage is greater than or equal to the first bus voltage threshold, commanding the at least one battery module to the OFF state.

Another aspect of the present disclosure is directed to a battery architecture, comprising: at least one battery module switchable between an ON state and an OFF state, the at least one battery module having a voltage bus; a positive contactor associated with at least one battery module; a negative contactor associated with at least one battery module; a controller configured to: command the positive contactor to open; determine whether a switch of the positive contactor indicates the positive contactor is open or closed, and: if the switch of the positive contactor indicates the positive contactor is open, command the negative contactor to open, or if the switch of the positive contactor indicates the positive contactor is closed, compare a bus voltage of the voltage bus to a first bus voltage threshold, and: if the bus voltage is less than the first bus voltage threshold, command the negative contactor to open, or if the bus voltage is greater than or equal to the first bus voltage threshold, command the at least one battery module to the OFF state.

A further aspect of the present disclosure is directed to a controller for at least one battery module, the at least one battery module being switchable between an ON state and an OFF state, the controller being configured to: command a positive contactor of the at least one battery module to open; determine whether a switch of the positive contactor indicates the positive contactor is open or closed, and: if the switch of the positive contactor indicates the positive contactor is open, command a negative contactor of the at least one battery module to open, or if the switch of the positive contactor indicates the positive contactor is closed, compare a bus voltage of the voltage bus to a first bus voltage threshold, and: if the bus voltage is less than the first bus voltage threshold, command the negative contactor to open, or if the bus voltage is greater than or equal to the first bus voltage threshold, command the at least one battery module to the OFF state.

### BRIEF DESCRIPTION OF THE DRAWINGS

FIG. 1 shows a battery architecture according to the present disclosure;

FIG. 2A shows a contactor of a battery module in an open position;

FIG. 2B shows a contactor a battery module in a closed position; and

FIG. 3 shows a method according to the present disclosure for controlling a contactor associated with a battery.

### DETAILED DESCRIPTION

The methods, battery architectures, and controllers of the present application can be used to distinguish genuine contactor faults from malfunctions of a switch of the contactor. Such strategies can be implemented in a variety of ways, including using the HV bus voltage or the voltage of a battery module, and helps to both reduce downtime and avoid damage to components.

In particular, the methods, battery architectures, and controllers described herein monitor different signals within a battery architecture and differentiate genuine contactor faults from contactor switch malfunctions that occur, for example: when a contactor is commanded to open, but the feedback switch of the contactor indicates the contactor is closed (i.e., the bus voltage equals the battery module voltage even after the contactor open command), indicating the contactor is welded close; when a contactor is commanded to close, but the feedback switch of the contactor indicates the contactor is open (i.e., the bus voltage does not build even after the contactor close command), indicating the contactor is stuck open; when a contactor is commanded to open, the feedback switch of the contactor indicates the contactor is closed (i.e., the bus voltage does not equal the battery module voltage even after the contactor open command), indicating a malfunction of the feedback switch; and when a contactor is commanded to close, but the feedback switch of the contactor indicates the contactor is open (i.e., the bus voltage starts building even after the contactor close command), also indicating a malfunction of the feedback switch.

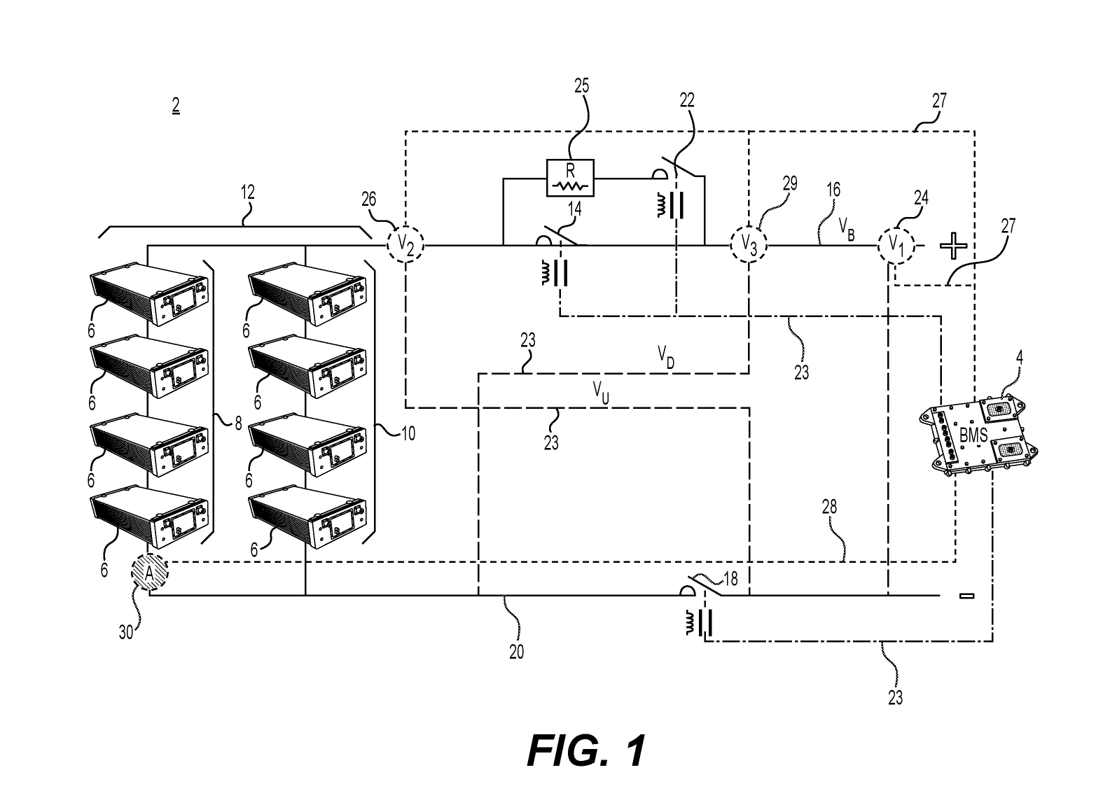

FIG. 1 shows a battery architecture 2. Battery architecture 2 may be used to supply voltage to power one or more loads, such as the drive system of a mobile machine (e.g., construction equipment) and/or the mobile machine’s implements. Battery architecture 2 includes a controller or BMS 4 that is operable to control and regulate battery modules 6 of battery architecture 2. In the example shown, two or more battery modules 6 can be connected in series to make a string, such as battery string 8 or battery string 10, each of which includes four battery modules 6. Furthermore, two or more battery strings, such as battery string 8 and battery string 10, can be connected in parallel to create a battery pack, such as battery pack 12.

A battery module 6 can be switched between an ON state and OFF state. For example, if battery architecture 2, which includes at least one battery module 6, is used in a mobile machine, an ignition key to that mobile machine can be switched between an ON state and OFF state. When the key is switched to the ON state, battery architecture 2 can provide voltage to power one or more loads associated with the mobile machine (e.g., to the drive system of a mobile machine). Specifically, turning the key to the ON state may close one or more contactors associated with the at least one battery module 6 of battery architecture 2 so that the at least one battery module 6 can supply voltage, bringing the at least one battery module 6 online. Battery module 6 can also be placed in the OFF state, or taken offline, by opening the one or more contactors associated with the at least one battery module 6. Specifically, battery module 6 can be placed in the OFF state by switching the key of the mobile machine to the OFF state, which in turn opens the one or more contactors associated with battery module 6.

The concept of switching between an ON state and OFF state is also applicable to a battery string, such as battery strings 8 and 10, as well as to a battery pack, such as battery pack 12, that includes one or more battery strings. Specifically, if battery architecture 2 must provide a greater voltage to power a larger load associated with a mobile machine, it may be desirable for battery architecture 2 to include a plurality of battery modules 6 arranged in one or more battery strings, such as battery strings 8 and 10. When the voltage provided by such a battery architecture 2 is not needed (e.g., when the mobile machine housing battery architecture 2 is not being operated), the operator of the mobile machine can switch the key of the mobile machine to an OFF state, which in turn places battery architecture 2 and its battery modules 6 in an OFF state. In this sense, the term “battery” may refer to an individual battery module 6, a battery string 8 or 10, a battery pack 12, or a battery architecture 2.

In this example, battery architecture 2 has a positive contactor 14 on voltage bus 16 and a negative contactor 18 on ground 20. Each of these contactors is associated with battery architecture 2 and its battery modules 6 in the sense that the contactors 14, 18 have the ability to connect and disconnect portions of the circuit provided by battery architecture 2. Voltage bus 16 may be an HV bus. Battery architecture 2 may also include one or more additional contactors, such as pre-charge contactor 22, which includes a pre-charge resistor 25. Controller 4, in turn can be connected to each of positive contactor 14, negative contactor 18, and pre-charge contactor 22 to monitor and control their status (i.e., whether the contactor is open or closed), through analog feedback lines 23 and sensor lines 27, respectively. Controller 4 can also be connected to one or more voltage sensors within battery architecture 2, such as first voltage sensor 24 that senses the voltage on voltage bus 16 downstream of positive contactor 14 with respect to ground, second voltage sensor 26 that senses the voltage on voltage bus 16 upstream of positive contactor 14 (i.e., the voltage produced by battery pack 12) and downstream of negative contactor 18, and third voltage sensor 29 that senses the voltage on voltage bus 16 downstream of positive contactor 14 and upstream of negative contactor 18. Connections between controller 4 and first voltage sensor 24, second voltage sensor 26, and third voltage sensor 29 can be sensor lines 27. Controller 4 may also be connected via a controller area network (“CAN”) datalink 28 to one or more sensors 30 on ground 20 or elsewhere within battery architecture 2.

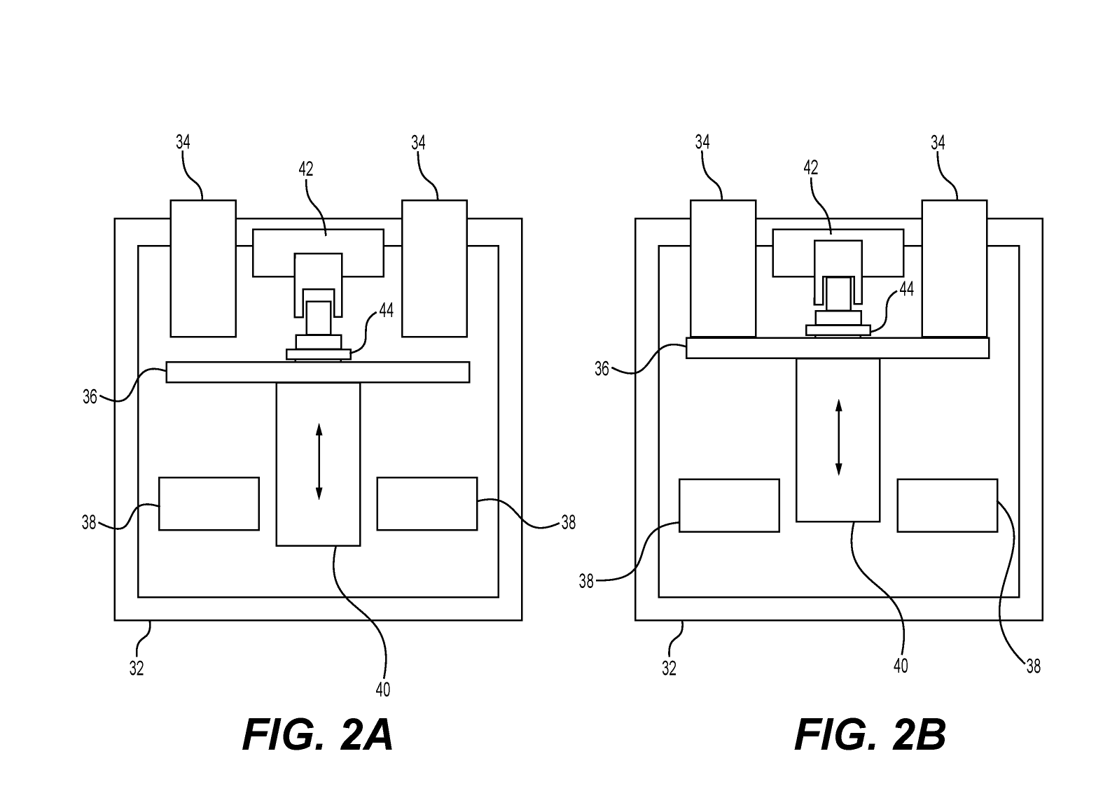

FIGS. 2A-2B show details of a contactor 32. Contactor 32 could be, for example, positive contactor 14 or negative contactor 18. In general, contactor includes a fixed contact 34 that can make electrical contact with movable contact 36. In FIG. 2A, there is no electrical contact between fixed contact 34 and movable contact 36, such that contactor 32 is referred to as being “open.” An open contactor 32 may be used to disrupt electrical current with a circuit, such as battery architecture 2. In FIG. 2B, in contrast, there is electrical contact between fixed contact 34 and movable contact 36, such that contactor 32 is referred to as being “closed.” A closed contactor 32 may be used to facilitate electrical current with a circuit, such as battery architecture 2.

Contactor 32 may be moved between open and closed positions using coil 38 and armature 40, which is connected to movable contact 36. When electrical current runs through coil 38, which surrounds armature 40, it creates an electromagnetic effect. Armature 40, in turn, is made of a ferromagnetic material, and can move in response to the electromagnetic effect created by coil 38. FIGS. 2A-2B each an include an arrow that shows the direction of movement of movable contact 36. In this manner it is possible to control movement of movable contact 36 with respect to fixed contact 34 (e.g., to open or close contactor 32).

Contactor 32 may also include a switch 42, which is intended to determine the position of movable contact 36 with respect to fixed contact 34 to ascertain whether contactor 32 is actually open or closed. More specifically, when movable contact 36 is not in electrical contact with fixed contact 34, switch 42 is not depressed, as shown in FIG. 2A. Switch 42 thus indicates that contactor 32 is open. But when movable contact 36 is in electrical contact with fixed contact 34, switch 42 is depressed, as shown in FIG. 2B. Switch 42 thus indicates that contactor 32 is closed. Contactor 32 may also include E-clip 44, which may act as a fastener and be disposed around a portion of armature 40.

As discussed herein, however, there are various failure modes of contactor 32. For example, it is possible for movable contact 36 of contactor 32 to become welded or fixed to fixed contact 34, rendering the contactor 32 unusable. Welding can result in a fault in battery architecture 2. It is also possible for switch 42 of contactor 32 to fail (e.g., to indicate that movable contact 36 is in contact with fixed contact 34 even though it is not), in which contactor 32 is still working properly from an electrical standpoint, even if switch 42 has malfunctioned. The methods, battery architectures, and controllers of the present application, however, distinguish genuine faults of contactor 32 (i.e., welding events) from malfunctions of switch 42 of the contactor 32.

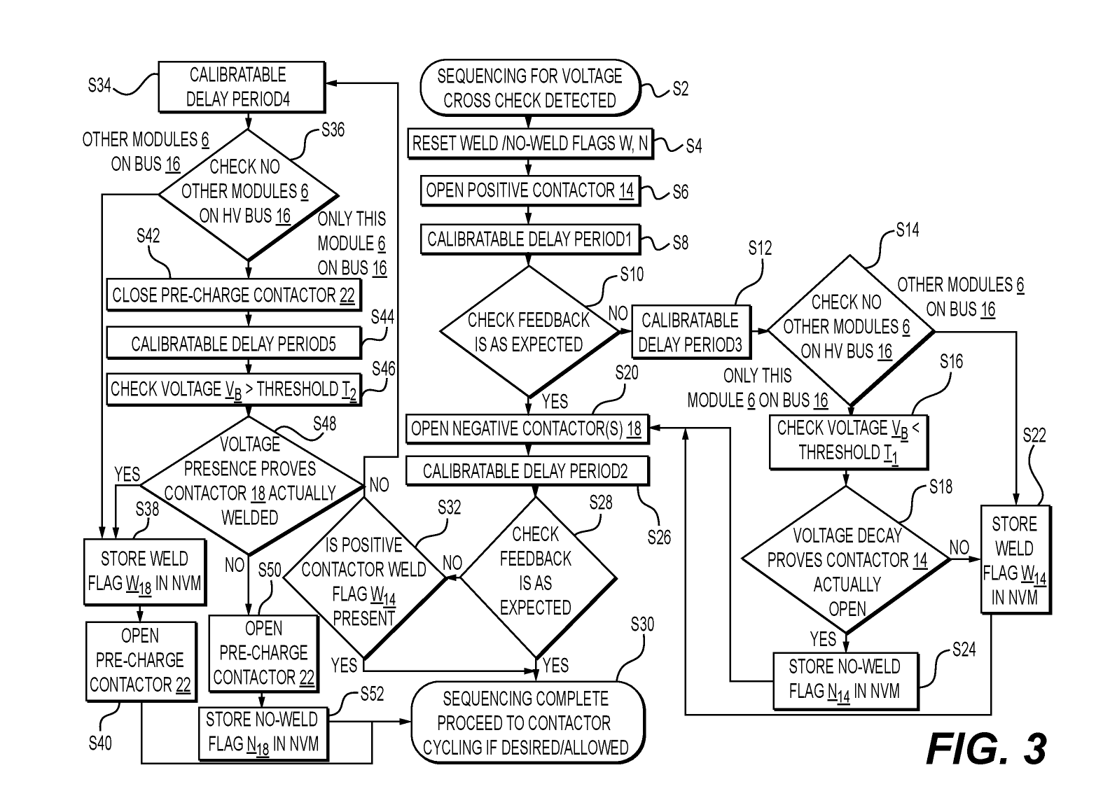

FIG. 3 shows a method for distinguishing contactor faults for at least one battery module 6 on a voltage bus, such as voltage bus 16 of battery architecture 2. The discussion herein focuses on at least one battery module 6, but is equally applicable if the at least one battery module 6 comprises four battery modules 6, as is the case in battery strings 8 and 10, or in the case of a battery pack that comprises a plurality of battery strings, such as battery pack 12. The at least one battery module 6 is switchable between an ON state and an OFF state.

The method, which may generally begin at S2, may include, at S6, commanding positive contactor 14 of battery architecture 2 to open. This command may be issued by, for example, controller 4, as shown in FIG. 1. Optionally, any weld flags W or non-weld flags N, as discussed in more detailed herein, may be reset in S4.

At S10, it is determined whether a switch 42 of positive contactor 14 indicates that positive contactor 14 is open or closed. If the switch 42 of the positive contactor 14 indicates the positive contactor 14 is open (i.e., the answer to decision S10 is “yes”), the method proceeds to S20, in which negative contactor 18 of battery architecture 2 is commanded to open. In other words, since positive contactor 14 has been commanded to open, switch 42 of positive contactor 14 should indicate that positive contactor 14 is open (i.e., that feedback is as expected) unless positive contactor 14 has welded or switch 42 of positive contactor 14 has malfunctioned. But if the switch 42 of the positive contactor 14 indicates the positive contactor 14 is closed (i.e., that feedback is not as expected and, the answer to decision S10 is “no”), the method may proceed to S16, in which a bus voltage V_{B} of the voltage bus 16 is compared to a first bus voltage threshold T₁.

In S18, if the bus voltage V_{B} is less than the first bus voltage threshold T₁, the voltage decay on voltage bus 16 indicates that positive contactor 14 is actually open, meaning that switch 42 of positive contactor 14 has malfunctioned. In this case, the negative contactor 18 of battery architecture 2 can be commanded to open, as in S20. However, if the bus voltage V_{B} is greater than or equal to the first bus voltage threshold T₁, the voltage decay on voltage bus 16 indicates that positive contactor 14 is not actually open, meaning that positive contactor 14 is welded. In this latter case, the at least one battery module 6 should be commanded to be in the OFF state so as to avoid damage to battery architecture 2. The at least one battery module 6 may be commanded to be in the OFF state by opening negative contactor 18, as in S20.

In an embodiment, if the bus voltage V_{B} is less than the first bus voltage threshold T₁, the method may include storing (e.g., in a non-volatile memory of controller 4) a positive contactor no-weld flag N₁₄, as in S24.

In an embodiment, if the bus voltage V_{B} is greater than or equal to the first bus voltage threshold T₁, the method may include storing (e.g., in a non-volatile memory of controller 4) a positive contactor weld flag W₁₄, as in S22.

In an embodiment, before comparing the bus voltage V_{B} to the first bus voltage threshold T₁ (i.e., before S16), the method may include determining whether the at least one battery module 6 comprises two or more battery modules 6, as in S14, and, if the at least one battery module 6 comprises two or more battery modules 6, commanding the negative contactor 18 to open, as in S20. The at least one battery module 6 will comprise two or more battery modules 6 if battery architecture 2 includes a battery string, such as battery string 8 or 10, or a battery pack, such as battery pack 12. If the at least one battery module 6 indeed comprises two or more battery modules 6, the method may include storing (e.g., in a non-volatile memory of controller 4) a positive contactor weld flag W₁₄, as in S22.

If the negative contactor 18 has been commanded to open, as in S18, the method may include determining whether a switch 42 of the negative contactor 18 indicates the negative contactor 18 is closed, as in S28. If the switch 42 of the negative contactor 18 indicates the negative contactor 18 is closed, the method may include determining whether a positive contactor weld flag W₁₄ has been stored, as in S32.

If in S32 the positive contactor weld flag has not been stored W₁₄ (meaning that positive contactor 14 is not welded and the answer to decision S32 is “no”), the method may include commanding a pre-charge contactor 22 of the at least one battery module 6 to close, as in S42. The pre-charge contactor 22 is shown in FIG. 1. Furthermore, if the pre-charge contactor 22 has been commanded to close, the method may include, in S46, comparing the bus voltage V_{B} to a second bus voltage threshold T₂. The second bus voltage threshold T₂ may be the same as or different than the first bus voltage threshold T₁. If the bus voltage V_{B} is less than the second bus voltage threshold T₂ (i.e., the answer to decision S48 is “no”), the pre-charge contactor 22 may be commanded to open, as in S50. Optionally, after pre-charge contactor 22 has been opened in S50, the method may include storing (e.g., in a non-volatile memory of controller 4) a negative contactor no-weld flag N₁₈. The method may proceed to step S30, in which, for example, positive contactor 14 and/or negative contactor 18 may be cycled if required, as in S30.

In other words, since negative contactor 18 has been commanded to open, switch 42 of negative contactor 18 should indicate that negative contactor 18 is open (i.e., that feedback is as expected) unless negative contactor 18 has welded or switch 42 of negative contactor 18 has malfunctioned. If switch 42 of negative contactor 18 indicates that negative contactor 18 is open (i.e., the answer to decision S48 is “yes”), the method may proceed to step S30, in which, for example, positive contactor 14 and/or negative contactor 18 may be cycled if required. But if the switch 42 of the negative contactor 18 indicates the negative contactor 18 is closed (i.e., that feedback is not as expected and the answer to decision S48 is “no”), the method may proceed to S50, in which pre-charge contactor 22 is commanded to open. This behavior is indicative of a malfunction of switch 42 of negative contactor 18.

If, however, the bus voltage V_{B} is greater than or equal to the second bus voltage threshold T₂ (i.e., the answer to decision S48 is “yes”), then the negative contactor 18 is welded. The method may then proceed to at least one of: commanding the at least one battery module 6 to the OFF state and commanding the pre-charge contactor to open, as in S40.

Returning to S32, if the positive contactor weld flag W₁₄ has not been stored, the method may include, if the at least one battery module 6 comprises two or more battery modules 6, as considered in S36, commanding pre-charge contactor 22 of the at least one battery module 6 to open, as in S40. Optionally, a negative contactor weld flag W₁₈ may be stored (e.g., in a non-volatile memory of controller 4), as in S38.

Returning to S10 in FIG. 3, if the switch 42 of the positive contactor 14 indicates the positive contactor 14 is open (i.e., the answer to decision S10 is “yes”) and if the negative contactor has been commanded to open (i.e., the answer to decision S20 is also “yes”), the method may also include determining whether a switch 42 of the negative contactor 18 or indicates the negative contactor 18 is closed, as in S28. If the switch 42 of the negative contactor 18 indicates the negative contactor 18 is closed (i.e., the answer to decision S28 is “no”), the method may include determining whether a positive contactor weld flag W₁₄ has been stored, as in S32.

If positive contactor weld flag W₁₄ has been stored (i.e., the answer to decision S32 is “yes”), the method may proceed to S30, in which, for example, positive contactor 14 and/or negative contactor 18 may be cycled if required.

But if the positive contactor weld flag W₁₄ has not been stored (i.e., the answer to decision S32 is “no”), the method may include commanding a pre-charge contactor 22 of the at least one battery module 6 to close, as in S42. Furthermore, as previously discussed, the method may then proceed to S46, in which bus voltage V_{B} is compared to second bus voltage threshold T₂. If the bus voltage V_{B} is less than the second bus voltage threshold T₂ (i.e., the answer to decision S48 is “no”), the pre-charge contactor 22 may be commanded to open, as in S50. Optionally, after pre-charge contactor 22 has been opened in S50, the method may include storing (e.g., in a non-volatile memory of controller 4) a negative contactor no-weld flag N₁₈. The method may proceed to step S30, in which, for example, positive contactor 14 and/or negative contactor 18 may be cycled if required, as in S30. If, however, the bus voltage V_{B} is greater than or equal to the second bus voltage threshold T₂ (i.e., the answer to decision S48 is “yes”), then the negative contactor 18 is welded. The method may then proceed to at least one of: commanding the at least one battery module 6 to the OFF state and commanding the pre-charge contactor to open, as in S40.

The method may also include implementing one or more calibratable delay periods, as in S8, S12, S26, S34, and/or S44.

In an alternative embodiment, an additional voltage sensor, such as third voltage sensor 29 in FIG. 1, may be used to distinguish contactor faults from switch malfunctions. For example, the method may further include sensing a downstream voltage V_{D} on the voltage bus 16 downstream of the positive contactor 14 and upstream of the negative contactor (e.g., using third voltage sensor 29), and using the downstream voltage V_{D} as the bus voltage V_{B}.

If the positive contactor 14 has been commanded to open, as in S6, the method may include determining whether a switch 42 of the positive contactor 14 indicates the positive contactor 14 is open or closed, as in S10. If the switch 42 of the positive contactor 14 indicates the positive contactor 14 is closed, the method may include sensing an downstream voltage V_{D} on the voltage bus 16 downstream of the positive contactor 14 and upstream of the negative contactor 18 (e.g., using third voltage sensor 29), then comparing the downstream voltage V_{D} to the first bus voltage threshold T₁. If the downstream voltage V_{D} is greater than or equal to the first bus voltage threshold T₁, the method may include commanding the at least one battery module 6 to the OFF state. More particularly, if the downstream voltage V_{D} is greater than or equal to the first bus voltage threshold T₁, the voltage decay on voltage bus 16 indicates that positive contactor 14 is not actually open, meaning that positive contactor 14 is welded.

Moreover, if the negative contactor 18 has been commanded to open, as in S20, the method may include determining whether a switch 42 of the negative contactor 18 indicates the negative contactor 18 is open or closed, as in S28. If the switch 42 of the negative contactor 18 indicates the negative contactor 18 is closed, the method may include sensing an upstream voltage V_{U} on the voltage bus 16 upstream of the positive contactor 14 and downstream of the negative contactor 18 (e.g., using second voltage sensor 26), then comparing the upstream voltage V_{U} to the second bus voltage threshold T₂. If the upstream voltage V_{U} is greater than or equal to the second bus voltage threshold T₂, the method may include commanding the at least one battery module 6 to the OFF state.

The method may also include implementing one or more calibratable delay periods, as in S8, S12, S26, S34, and/or S44.

Other variations of the preceding methods are also possible and within the scope of the present application. For example, various steps of the methods could be omitted and/or reordered without departing from the scope of the present application.

### INDUSTRIAL APPLICABILITY

In general, the systems, methods, and controllers of the present application provide the ability to distinguish genuine contactor faults due to welding from malfunctions of a switch of the contactor. The systems, methods, and controllers of the present application can do this both with and without an additional voltage sensor. Through a particular arrangement of contactors and voltage sensors on the HV bus and logic/sequencing of the contactors to determine their position using the above arrangement, it is possible to determine the position of the contactors using the voltage sensing and sequencing. Once the correct status of the contactor is determined, the contactor may then be commanded to open and close a specified number of times, restoring the reliable functionality of the contactor. Faults can be cleared after reliable functionality is restored. In view of the foregoing, the systems, methods, and controllers of the present application reduce machine downtime and avoid damage to components.

What is claimed is:

1. A method for distinguishing faults for at least one battery module on a voltage bus, the at least one battery module being switchable between an ON state and an OFF state, the method comprising:
commanding a positive contactor of the at least one battery module to open;
determining whether a switch of the positive contactor indicates the positive contactor is open or closed, and:
if the switch of the positive contactor indicates the positive contactor is open, commanding a negative contactor of the at least one battery module to open, or
if the switch of the positive contactor indicates the positive contactor is closed, comparing a bus voltage of the voltage bus to a first bus voltage threshold, and:
if the bus voltage is less than the first bus voltage threshold, commanding the negative contactor to open, or
if the bus voltage is greater than or equal to the first bus voltage threshold, commanding the at least one battery module to the OFF state.

2. The method of claim 1, wherein, if the bus voltage is less than the first bus voltage threshold, the method further comprises:
storing a positive contactor no-weld flag.

3. The method of claim 1, wherein, if the bus voltage is greater than or equal to the first bus voltage threshold, the method further comprises:
storing a positive contactor weld flag.

4. The method of claim 1, wherein, before comparing the bus voltage to the first bus voltage threshold, the method further comprises:
determining whether the at least one battery module comprises two or more battery modules, and, if the at least one battery module comprises two or more battery modules, commanding the negative contactor to open.

5. The method of claim 4, wherein, if the at least one battery module comprises two or more battery modules, the method further comprises:
storing a positive contactor weld flag.

6. The method of claim 5, wherein, if the negative contactor has been commanded to open, the method further comprises:
determining whether a switch of the negative contactor indicates the negative contactor is closed.

7. The method of claim 6, wherein, if the switch of the negative contactor indicates the negative contactor is closed, the method further comprises:
determining whether the positive contactor weld flag has been stored.

8. The method of claim 7, wherein, if the positive contactor weld flag has not been stored, the method further comprises:
commanding a pre-charge contactor of the at least one battery module to close.

9. The method of claim 8, wherein, if the pre-charge contactor has been commanded to close, the method further comprises:
comparing the bus voltage to a second bus voltage threshold, and:
if the bus voltage is less than the second bus voltage threshold, commanding the pre-charge contactor to open, or
if the bus voltage is greater than or equal to the second bus voltage threshold, at least one of: commanding the at least one battery module to the OFF state and commanding the pre-charge contactor to open.

10. The method of claim 7, wherein, if the positive contactor weld flag has not been stored, the method further comprises:
if the at least one battery module comprises two or more battery modules, commanding a pre-charge contactor of the at least one battery module to open.

11. The method of claim 1, wherein, if the switch of the positive contactor indicates the positive contactor is open and if the negative contactor has been commanded to open, the method further comprises:
determining whether a switch of the negative contactor indicates the negative contactor is closed.

12. The method of claim 11, wherein, if the switch of the negative contactor indicates the negative contactor is closed, the method further comprises:
determining whether a positive contactor weld flag has been stored.

13. The method of claim 12, wherein, if the positive contactor weld flag has not been stored, the method further comprises:
commanding a pre-charge contactor of the at least one battery module to close.

14. The method of claim 13, wherein, if the pre-charge contactor has been commanded to close, the method further comprises:
comparing the bus voltage to a second bus voltage threshold, and:
if the bus voltage is less than the second bus voltage threshold, commanding the pre-charge contactor to open, or
if the bus voltage is greater than or equal to the second bus voltage threshold, at least one of: commanding the at least one battery module to the OFF state and commanding the pre-charge contactor to open.

15. The method of claim 12, wherein, if the positive contactor weld flag has not been stored, the method further comprises:
if the at least one battery module comprises two or more battery modules, commanding a pre-charge contactor of the at least one battery module to open.

16. The method of claim 1, further comprising::
sensing a downstream voltage on the voltage bus downstream of the positive contactor and upstream of the negative contactor, and
using the downstream voltage as the bus voltage.

17. The method of claim 16, wherein, if the negative contactor has been commanded to open, the method further comprises:
determining whether a switch of the negative contactor indicates the negative contactor is open or closed, and
if the switch of the negative contactor indicates the negative contactor is closed, sensing an upstream voltage on the voltage bus upstream of the positive contactor and downstream of the negative contactor, comparing the upstream voltage to a second bus voltage threshold, and, if the upstream voltage is greater than or equal to the second bus voltage threshold, commanding the at least one battery module to the OFF state.

18. A battery architecture, comprising:
at least one battery module switchable between an ON state and an OFF state, the at least one battery module having a voltage bus;
a positive contactor associated with at least one battery module;
a negative contactor associated with at least one battery module;
a controller configured to:
command the positive contactor to open;
determine whether a switch of the positive contactor indicates the positive contactor is open or closed, and:
if the switch of the positive contactor indicates the positive contactor is open, command the negative contactor to open, or
if the switch of the positive contactor indicates the positive contactor is closed, compare a bus voltage of the voltage bus to a first bus voltage threshold, and:
if the bus voltage is less than the first bus voltage threshold, command the negative contactor to open, or
if the bus voltage is greater than or equal to the first bus voltage threshold, command the at least one battery module to the OFF state.

19. The battery architecture of claim 18, further comprising:
a voltage sensor configured to sense a downstream voltage on the voltage bus downstream of the positive contactor and upstream of the negative contactor,
wherein the controller is configured to use the downstream voltage as the bus voltage.

20. A controller for at least one battery module, the at least one battery module being switchable between an ON state and an OFF state, the controller being configured to:
command a positive contactor of the at least one battery module to open;
determine whether a switch of the positive contactor indicates the positive contactor is open or closed, and:
if the switch of the positive contactor indicates the positive contactor is open, command a negative contactor of the at least one battery module to open, or
if the switch of the positive contactor indicates the positive contactor is closed, compare a bus voltage of the voltage bus to a first bus voltage threshold, and:
if the bus voltage is less than the first bus voltage threshold, command the negative contactor to open, or
if the bus voltage is greater than or equal to the first bus voltage threshold, command the at least one battery module to the OFF state.
